(19) United States
(12) Patent Application Publication
(10) Pub. No.: US 2026/0108798 A1
(43) Pub. Date: Apr. 23, 2026

(54) Frame with a front wheel and seat for riding an electric skateboard while sitting

(71) Applicant: Albert Kurdzialek, JR., Fountain Hills, AZ (US)

(72) Inventor: Albert Kurdzialek, JR., Fountain Hills, AZ (US)

(21) Appl. No.: 19/365,131

(22) Filed: Oct. 21, 2025

Related U.S. Application Data
(60) Provisional application No. 63/709,728, filed on Oct. 21, 2024.

(51) Int. Cl. A63C 17/28; A63C 17/12; B62K 5/027; B62K 5/06; B62K 11/14; B62K 13/04; B62K 13/08; B62K 21/12; B62K 23/04

(52) U.S. Cl. CPC A63C 17/28; A63C 17/12; B62K 5/027; B62K 5/06; B62K 11/14; B62K 13/04; B62K 13/08; B62K 21/12; B62K 23/04; A63C 2203/06; A63C 2203/12; A63C 2203/14

(57) ABSTRACT

A conversion frame adds a steering tire and a seat to an electric skateboard. The front wheel provides more stability and allows the rider to sit on a seat above the skateboard. The conversion frame makes an electric skateboard more stable, and the rider is low to the ground, enhancing fall safety. The steering tire allows for faster speeds and safer turns without a dangerous fall. It also gives more enjoyment as a lower view at typical skateboard speeds will appear faster to the rider.

### CROSS REFERENCE TO RELATED APPLICATIONS

This application claims the benefit of provisional application No. 63/709,728 filed on Oct. 21, 2024. The prior provisional application is incorporated by reference herein.

### BACKGROUND OF THE INVENTION

### (1) Field of the Invention

This invention is directed to skateboard modifications and adaptations that provide for better safety and broadens the use of a skateboard.

### (2) General Discussion

Electric skateboards are an important market for personal motion. These vehicles require a handheld remote, usually wireless, to operate the vehicle speed and motion. Typically, the wireless remote control is equipped with convenient functions, such as adjustable brakes, data recording, cruising at a fixed speed, acceleration or deceleration, forward or braking modes, among other features.

The electric skateboard is useful for longer trips and hills. Some electric skateboards are designed to travel as fast as 30 mph with a range of 25 miles, with the distance depending upon battery storage. That kind of travel distance results in navigating a variety of terrains, road hazards, car traffic, and pedestrians. The demand for standing vertically and safely responding to instant issues such as rocks, collisions, etc. is high.

Electric skateboards are not purchased for their ability to perform tricks; they are typically purchased for short commuter needs. For example, a 5-mile commute to work (and back) would consume 75 watt-hours (0.075 kWh). For an electrical price of $0.12 per kWh, the daily commute in either direction is $0.009. With 40 commutes each month, electricity costs are only $0.36. This affordability with a faster commute is highly attractive.

Generally speaking, electric skateboards require a handheld remote, are incapable of sensing the rider's body position, and suffer difficulties with rider safety and stability. Electric skateboards have two main limitations: a) they are difficult to fully master and b) they cannot avoid sudden problems which will cause the rider to fall.

To address these issues, a better electric skateboard design is needed that provides the same sense of fun as well as improving safety when used for longer distances.

### BRIEF STATEMENT OF THE INVENTION

A skateboard conversion frame adds a steering tire and a seat to an electric skateboard. The front wheel provides more stability and allows the rider to sit on a seat above the skateboard. The conversion frame makes an electric skateboard more stable, and the rider is low to the ground, enhancing fall safety. The steering tire allows for faster speeds and safer turns without a dangerous fall. It also gives more enjoyment as a lower view at typical skateboard speeds will appear faster to the rider.

The forward motion is controlled by the electric controller for the electric skateboard, and includes electric braking. The front tire includes a disc brake that is positioned on the handlebar and manually activated. Foot-rests are added to the conversion frame for operator convenience. The conversion frame uses a c shaped groove to grip the skateboard.

### BRIEF DESCRIPTION OF THE FIGURES

FIG. 1 shows a top view of the skateboard conversion frame.

FIG. 2 shows a side view of the skateboard conversion frame.

FIG. 3 shows a side view of the skateboard with the front steering tire and a skateboard.

FIG. 4 shows a side view of an alternate embodiment of a deck plate seated skateboard.

### DETAILED DESCRIPTION OF THE INVENTION

### Features of the Embodied Invention

101 Head Tube
102 Head Tube Extension
103 Front Frame
104 Flex Pin
105 Front Plate
106 Front Tube Frame
107 Seat Holes
108 Front Bracket Adjust
109 Foot-Rest
110 Skateboard Frame
111 Rear Frame Adjust
201 Front Brace Frame
202 Bottom Bracket
301 Handlebars
302a Front Wheel Tire
302b Front Wheel Rim
304 Fork
305 Skateboard
306 Elect power and gearing
307 Skateboard rear wheel
308 Seat Cushion
309 Fasteners
310 Seat Vertical Support
311 Flat Seat Horizontal Support Board
312 Electric Controller Case
313 Electric Controller
314 Rim Brake
401 Deck Plate
402 Bracket

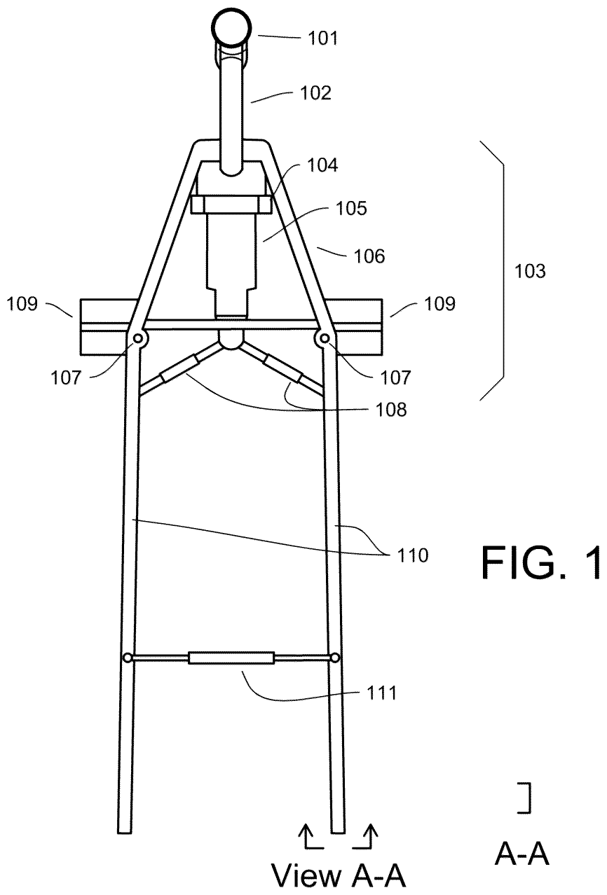

The main embodiment of FIGS. 1-3 provides for better comfort and stability when utilizing a skateboard for both short and long distances. The ability to use hands for making a turn do not require the balancing skill needed for a skateboard while standing upright.

The use of a conversion frame also provides more sport fun as the design allows the rider to lean when turning the handlebars. The position of the front steering tire is forward of the rider. When turning the handlebars, the wheel will naturally lean the conversion frame when it is turned left or right. Consequently, the rider will naturally lean with the turn and that will give a ‘motorcycle’ feeling when riding. Typical rear skateboard wheels are also designed to lean.

A preferred embodiment as illustrated by FIGS. 1-3 is described as follows.

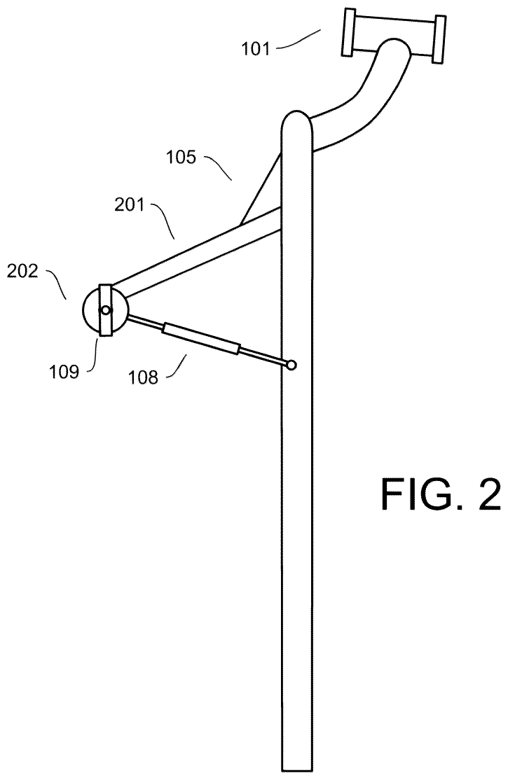

FIG. 1 shows a top view of the conversion frame. A head tube 101 support a front wheel and handlebars. The head tube is connected to the front frame 103 by a head tube extension 102. The front frame is connected to a rotating flex pin 104 that provides frame flexibility for adapting to various skateboards. The flex pin is connected to a front plate 105 that is connected to a bottom bracket 202 by a front brace frame 201 (see FIG. 2).

The front tube frame 106 is connected to the skateboard frame 110. The skateboard frame uses slotted bars that will securely hold skateboard within the slots. A rear frame adjusting element (e.g. turnbuckle) 111 allows the frame to be adapted for various skateboard widths. The turnbuckle is preferably tightened enough to secure the skateboard, but not so much as to cause damage.

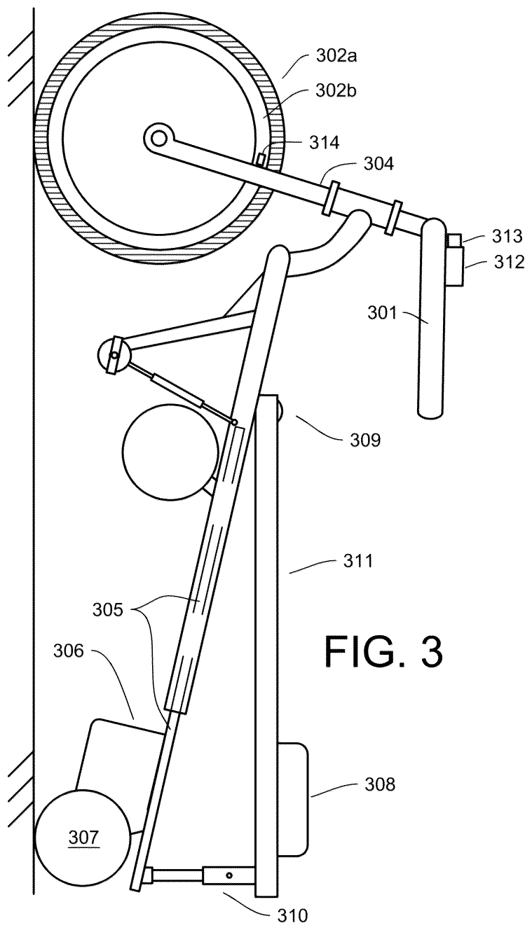

The front frame includes seat connecting holes 107 that are used to connect to seat fasteners 309 (see FIG. 3). The front frame also includes a pair of front adjustment bracket 108 and a footrest 109. The front adjustment brackets 108 are used to tighten the frame when connecting to the electric skateboard, and provide flexibility for various skateboard dimensions.

View A-A shows that a c channel frame is used to grip the skateboard.

For clarification, FIG. 2 additionally shows a front bracket frame 201 that connects the front plate 105 to the bottom bracket 202. The front plate provides protection from tire spray, and is a vertical adjustment.

FIG. 3 shows a side view of the conversion frame with a front wheel 302a with handlebars 301, a seat cushion 308, and an electric skateboard 305. The seat cushion is simply connected to a horizontal flat plate 311, that is connected to the conversion frame by fasteners 309. Optionally, the horizontal flat plate is connected by a hinge to the conversion frame. Optionally, the horizontal flat plate includes a slot for positioning the seat cushion 308 forward or backward. An adjustable seat support 310 with bottom padding is used to provide more comfortable seating for the rider and avoid the feeling that the rider is slipping backward.

The handlebar includes a holding case 312 for the electric skateboard controller 313, and is positioned for easy access by a thumb.

Preferably, the conversion frame includes a front light mounted on the fork, and rear light (or reflectors) on the horizontal flat plate. Also, for rider convenience, the conversion frame includes a kickstand.

The embodied conversion frame is meant to be a flexible design and can be adapted to many types of skateboards and lengths. Additional hardware can be added to the conversion frame such as clamps, fasteners, and grips with rubber cushions. The conversion frame can include frame cutouts, bends, and a specialized connection plate to the skateboard that replaces the front wheels of the skateboard. The plate can be generic in design by using slots to connect to the board, or a specialized plate that is built to match the plate fastener design.

The embodied invention is not limited to the rectangular frame shape of FIGS. 1-3. It can be round, oval, or a polygon, among other designs. It optionally includes a front brake to make it easy to stop. Padding on the illustrated seat is a preferred option for long term riding.

The design allows foot sliding as a brake, and for stability when making a hard turn or braking hard. This technique will come naturally to a skateboarder.

If the skateboard separates from the conversion frame due to improper installation or a failure of some kind, the vertical seat support will act like a brake and will stop the conversion frame by sliding on the ground.

A front disc brake or wheel rim grip brake 314 can be added to the conversion frame for easy braking along with the electric skateboard brake function. Preferably, the electric controls at a minimum include adjustable cruising speeds and the ability to accelerate or decelerate (braking).

The electric skateboard is operable by using a handheld controller or by including the controller on the handlebar.

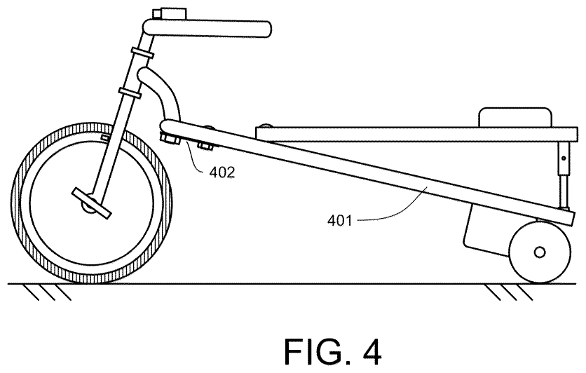

In an alternate embodiment, FIG. 4 shows how the invention can be built in its entirety at a factory by including the skateboard functions on a deck plate 401 driven by wheels and a motor. A deck plate electric skateboard is connected to the head tube extension by metal bracket 402, or other attaching means such as welding. The deck plate skateboard includes the essential riding functions of a skateboard conversion frame to a single frame. It includes the same riding functions such as:
1) The ability to convert rider input—weight, balance, and movement—into controlled motion, turning, and stopping actions.
2) Mounting the wheels and motor on a deck plate with a seat. The deck plate is preferably at an angle from the ground for construction simplicity, but this is not a requirement.
3) The wheels include bearings, and mounting hardware.
4) It allows the rider to lean toward the ground when making fast turns, similar to a motorcycle or electric bike.
5) A handheld controller, or a speed-stopping control, is included on the handlebars. The controller operates the motor, preferably by rotating a hand grip.
6) The frame design similarly balances stability, maneuverability, and safety for a variety of riding styles and environments.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A conversion frame for riding an electric skateboard while sitting comprising:
A) a front frame connected to a front steering tire operable by a connected handlebar,
B) said front frame connected to a skateboard frame,
C) said skateboard frame connected to an electric skateboard, said electric skateboard having a plurality of propulsion wheels,
D) a seat connected to said skateboard frame, said seat elevated above said electric skateboard by an adjustable vertical member,
E) said skateboard frame positions said propulsion wheels on the ground, and
F) whereby said handlebar operable to control a direction of said conversion frame during propulsion.

2. A conversion frame with a front tire and seat for riding an electric skateboard while sitting comprising:
A) a head tube connected to a front frame,
B) said front frame connected to a flex pin,
C) said flex pin connected to a front plate,
D) said front plate connected to a front brace,
E) said front brace connected to a bottom bracket,
F) said bottom bracket connected to:
A) an adjustment bracket, and
B) a pair of foot rests,
G) said front frame connected to a skateboard frame,
H) said skateboard frame connected to an electric skateboard, said electric skateboard secured to said skateboard frame by a turnbuckle,
I) a handlebar rotatably connected to said head tube,
J) said front tire connected to said fork,
K) a seat connected to said skateboard frame and elevated above said electric skateboard by an adjustable vertical member, and
L) whereby said handlebar operable to control the direction of said conversion frame when said electric skateboard propels said conversion frame in motion.

3. An apparatus for riding a deck plate electric skateboard, comprising:
A) a front steering assembly operable by a handlebar, configured to provide directional control and stability during motion,
B) a frame structure configured to support a seat above a deck plate, the seat being adjustable in height and position to accommodate a seated rider and enhance safety by lowering the center of gravity,
C) a braking system comprising a manually actuated front wheel brake and an integrated electric brake to provide a controlled deceleration,
D) a footrest pair positioned to support the rider's feet during operation, the footrest pair facilitating ergonomic posture and improved control,
E) whereby the apparatus enables the rider to operate the deck plate skateboard while seated, providing enhanced stability, safety, and comfort compared to conventional standing operation.

4. The apparatus of claim 3, wherein:
A) the steering assembly is configured to translate handlebar input into front wheel rotation, allowing the rider to lean naturally into turns and experience improved maneuverability;
B) the seat assembly includes a vertical support member and a horizontal support board, both adjustable to accommodate rider preference and maintain rider stability;
C) the braking system allows simultaneous or independent use of manual and electric brakes, optimizing stopping power for various riding conditions.

5. The apparatus of claim 3, further comprising:
A) a controller mount integrated into the handlebar, enabling intuitive access to the deck plate skateboard's speed and braking controls while seated;
B) lighting fixtures and reflectors positioned for visibility and safety during low-light operation;
C) a kickstand attached to the frame for convenient parking and stability when not in use.

6. The apparatus of claim 3, wherein separation of the skateboard from the frame triggers a passive braking action via the seat support contacting the ground, thereby reducing runaway risk and enhancing rider safety.

7. The apparatus of claim 3, whereby the design allows adaptation to skateboards of various shapes, sizes, and wheel configurations, thereby broadening the applicability and user base of the invention.
